(19) United States
(12) Patent Application Publication
(10) Pub. No.: US 2014/0294474 A1
(43) Pub. Date: Oct. 2, 2014

(54) IMAGE FORMING APPARATUS

(71) Applicant: CANON KABUSHIKI KAISHA, Tokyo (JP)

(72) Inventors: Junya Akatsuka, Kawasaki-shi (JP); Masaki Tanaka, Kawasaki-shi (JP); Daisuke Aoki, Yokohama-shi (JP)

(73) Assignee: CANON KABUSHIKI KAISHA, Tokyo (JP)

(21) Appl. No.: 14/224,413

(22) Filed: Mar. 25, 2014

(30) Foreign Application Priority Data
Apr. 1, 2013 (JP) 2013-075601

(51) Int. Cl. G03G 15/20

(52) U.S. Cl. CPC G03G 21/206
USPC 399/341

(57) ABSTRACT

With the present invention, an image forming apparatus is prevented in which a recording material on which a toner image is heated and fixed and which is discharged is cooled, and the toner image heated and fixed onto the recording material is prevented from being melted. Further, a conveying portion is prevented from being cooled, so that unevenness of cooling of the toner image is prevented, and the image forming apparatus does not cause any contact mark of the conveying portion.

An air-blowing duct is provided to guide external air to the recording material conveyed by a discharge roller and a discharge driven roller provided at a downstream side of a fixing device, and a blowing port of the air-blowing duct is open at a position avoiding the discharge roller and the discharge driven roller.

### BACKGROUND OF THE INVENTION

1. Field of the Invention

The present invention relates to an image forming apparatus for forming a toner image on a recording material.

2. Description of the Related Art

A recording material discharged immediately after a toner image formed on the recording material has been heated and fixed is at a high temperature. In normal circumstances, immediately after the heating and fixing process, the recording material is discharged to a discharge tray by, e.g., a discharge roller. Accordingly, high-temperature recording materials are stacked on the discharge tray, and the toner image that has been heated and fixed onto the recording material may be melted again by the high-temperature recording materials that have been discharged, and the toner image may stick to the back surface of the recording material.

In order to solve such a problem, external air that has been drawn by, e.g., a fan is blown onto the recording materials discharged onto the discharge tray to cool the recording materials, so that the toner image that has been heated and fixed on the recording material is prevented from being melting again.

For example, Japanese Patent Laid-Open No. 2005-77565 indicates that a cooling fan cools a portion around a discharge roller provided at a downstream side with respect to a fixing device, and in accordance with whether a discharge device is attached or not, the flow of air from the cooling fan is changed.

When a high-temperature recording material is stacked on a discharge tray, a toner image heated and fixed on the recording material is melted again by high-temperature recording materials discharged previously. Accordingly, the toner image attaches to the back surface of the recording material. In order to prevent this, the recording material is cooled by blowing external air, which is retrieved by, e.g., a fan, onto the recording material discharged onto the discharge tray, and the toner image heated and fixed on the recording material is prevented from being melted again.

However, when the recording material is cooled, the discharge roller and the like are also cooled, and therefore, unevenness of cooling occurs in the toner image because of the difference in the temperature between the recording material discharged immediately after the heating and fixing process and the discharge roller and the discharge driven roller, and failure may occur in the image, e.g. occurrence of contact marks of the discharge roller and the discharge driven roller.

The present invention is to solve the above problem, and it is desirable to cool the recording material on which the toner image has been heated and fixed and which has been discharged, and the toner image which has been heated and fixed on the recording material is prevented from being melted again. Further, the present invention is to provide an image forming apparatus that prevents the conveying portion from being cooled, thus preventing unevenness of cooling of the toner image, and not making any contact mark of the conveying portion.

### SUMMARY OF THE INVENTION

A representing configuration of an image forming apparatus according to the present invention for achieving the above object includes a toner image forming portion configured to form a toner image on a recording material, a fixing portion configured to fix the toner image formed by the toner image forming portion onto the recording material, a pair of rollers which is provided at a downstream side in a conveying direction of a recording material with respect to the fixing portion, and which sandwiches and conveys the recording material, an air-blowing portion configured to blow air, and a guide portion configured to guide air blown by the air-blowing portion to a recording material conveyed by the pair of rollers, wherein the guide portion includes a blowing port in proximity to the pair of rollers and at a position avoiding the pair of rollers.

Further features of the present invention will become apparent from the following description of exemplary embodiments with reference to the attached drawings.

### BRIEF DESCRIPTION OF THE DRAWINGS

FIG. 1 is a sectional explanatory diagram illustrating a configuration of an image forming apparatus according to the present invention.

FIG. 2 is a perspective explanatory diagram illustrating a configuration in proximity to a conveying portion according to a first embodiment of the image forming apparatus according to the present invention.

FIG. 3 is a sectional explanatory diagram illustrating a configuration in proximity to a conveying portion of the image forming apparatus of the first embodiment.

FIG. 4 is a top view explanatory diagram illustrating a configuration in proximity to the conveying portion of the image forming apparatus of the first embodiment.

FIG. 5 is a perspective explanatory diagram illustrating a configuration in proximity to a conveying portion of a second embodiment of the image forming apparatus according to the present invention.

FIG. 6 is a top view explanatory diagram illustrating a configuration in proximity to the conveying portion of the image forming apparatus of the second embodiment.

FIG. 7 is a top view explanatory diagram illustrating a configuration of an opening width, in the recording material conveying direction, of the blowing port of the image forming apparatus of the second embodiment at a position facing the pair of rollers, and an opening width, in the recording material conveying direction, of the blowing port of the image forming apparatus of the second embodiment at the position not facing the pair of rollers.

### DESCRIPTION OF THE EMBODIMENTS

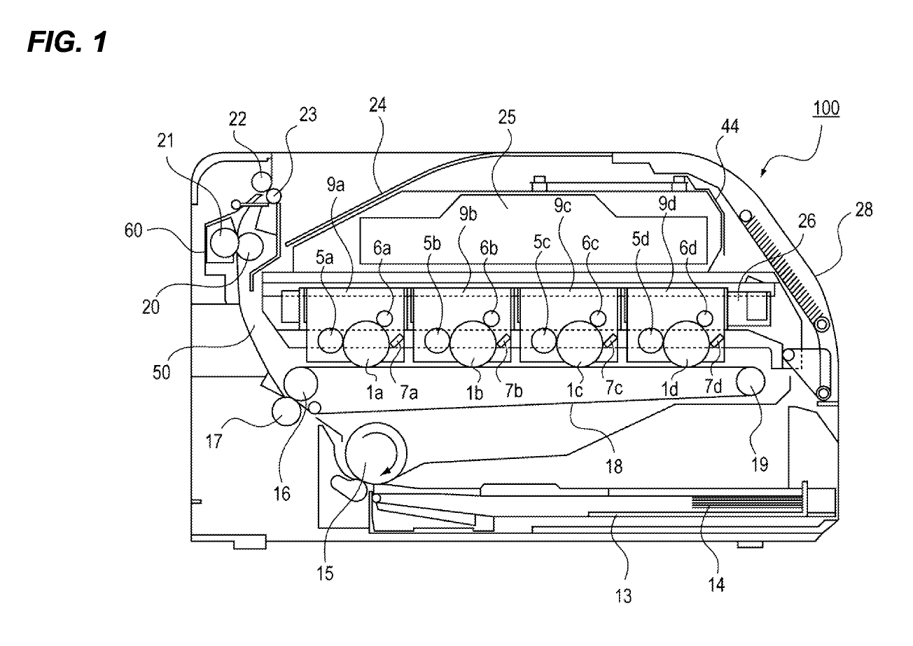

Embodiments of an image forming apparatus according to the present invention will be described with reference to drawings in a more specific manner.

[First Embodiment] First, a configuration of the first embodiment of an image forming apparatus according to the present invention will be described with reference to FIGS. 1 to 4. In the present embodiment, an example in a case where the present embodiment is applied to a full-color laser beam printer will be described as an example of an image forming apparatus 100. It should be noted that the image forming apparatus 100 can be applied to not only a full color laser beam printer but also various kinds of image forming apparatuses such as a color electrophotographic copying machine and a facsimile device.

<Image forming apparatus> First, a configuration of a color electrophotographic image forming apparatus (which will be hereinafter referred to as “image forming apparatus”) 100 will be described with reference to FIG. 1. FIG. 1 is a sectional explanatory diagram illustrating a configuration of the image forming apparatus 100. It should be noted that the main body of the image forming apparatus 100 is a configuration obtained by removing process cartridges 9a, 9b, 9c, 9d and a cartridge tray 26 serving as a cartridge support member from the image forming apparatus 100. It should be noted that, for the sake of description, the process cartridges 9a, 9b, 9c, 9d may be referred to as process cartridges 9 which simply representing the process cartridges 9a, 9b, 9c, 9d. This is also applicable to other image forming process portions.

It should be noted that, in the description below, the closer side (forward side) of the image forming apparatus 100 means a side where a door 28 serving as an open/close member configured to be able to open/close is provided on the main body of the image forming apparatus 100 (right side of FIG. 1). It should be noted that the door 28 closes, in an openable manner, an opening provided in an external wall 44 of the main body of the image forming apparatus 100. The farther side (backward side) of the main body of the image forming apparatus 100 means a side where a conveying path 50 for a recording material 14 is provided (left side of FIG. 1) which is the opposite to the side where the door 28 is provided.

In the main body of the image forming apparatus 100, e.g., a sheet cassette 13 accommodating the recording materials 14, a feeding/conveying roller 15, an intermediate transfer belt 18, a fixing film 20 and a pressure roller 21 constituting a fixing device 60 serving as a fixing portion, and a laser scanner 25 are provided. The main body of the image forming apparatus 100 is also provided with a cartridge tray 26 provided to be movable. The cartridge tray 26 supports, in a detachable manner, the process cartridges 9 serving as a toner image forming portion which forms a toner image onto the recording material 14.

The process cartridges 9 include photosensitive drums 1a, 1b, 1c, 1d serving as image bearing members made of drum-shaped electrophotographic photosensitive bodies and developing rollers 5a, 5b, 5c, 5d serving as developing members constituting image forming process portions exerting on the photosensitive drums 1. Further, charging rollers 6a, 6b, 6c, 6d, serving as charging members and cleaning blades 7a, 7b, 7c, 7d serving as cleaning members are integrally provided. Each process cartridge 9 is detachably attached to the cartridge tray 26, and is attached to an image forming position in the main body of the image forming apparatus 100.

The recording materials 14 stacked in the sheet cassette 13 are fed and conveyed by the feeding/conveying roller 15 rotating in a clockwise direction of FIG. 1, and is conveyed to a transfer nip portion between the driving roller 16 of the intermediate transfer belt 18 and the transfer roller 17 serving as a transfer portion. The photosensitive drum 1 starts rotation in a counterclockwise direction of FIG. 1, and the external peripheral surface thereof is charged by the charging roller 6. Laser light is emitted by the laser scanner 25, serving as an exposure portion, onto the photosensitive drum 1, which has been charged, in accordance with image information.

Accordingly, electrostatic latent images are formed on the surfaces of the photosensitive drums 1 in order. Subsequently, toner serving as developer is supplied by a developing roller 5 to the surface of the photosensitive drum 1, so that the electrostatic latent image is developed. Accordingly, the toner images are formed on the external peripheral surfaces of the photosensitive drums 1. It should be noted that the process cartridges 9 are the same except that the colors of the developers contained within the developer containers are different.

The process cartridge 9a contains developer in yellow color, and forms a toner image in yellow color on the photosensitive drum 1a. The process cartridge 9b contains developer in magenta color, and forms a toner image in magenta color on the photosensitive drum 1b. The process cartridge 9c contains developer in cyan color, and forms a toner image in cyan color on the photosensitive drum 1c. The process cartridge 9d contains developer in black color, and forms a toner image in black color on the photosensitive drum 1d.

The toner image formed on the surface of the photosensitive drum 1 is transferred onto the external peripheral surface of the intermediate transfer belt 18. When a color image is formed, toner images in yellow color, magenta color, cyan color, and black color formed on the photosensitive drums 1 are primarily transferred onto the external peripheral surface of the intermediate transfer belt 18 in a sequentially superimposed manner. The intermediate transfer belt 18 is an endless belt rotating and moving by being in contact with each photosensitive drum 1, and is wrapped around the driving roller 16, the tension roller 19, and the like in a tensional manner.

The toner image transferred onto the external peripheral surface of the intermediate transfer belt 18 is secondarily transferred onto the recording material 14 that is fed to the transfer nip portion between the driving roller 16 and the transfer roller 17. The recording material 14 having the toner image transferred thereon is conveyed to the fixing nip portion between the fixing film 20 and the pressure roller 21, and is heated and pressurized at the fixing nip portion between the fixing film 20 and the pressure roller 21.

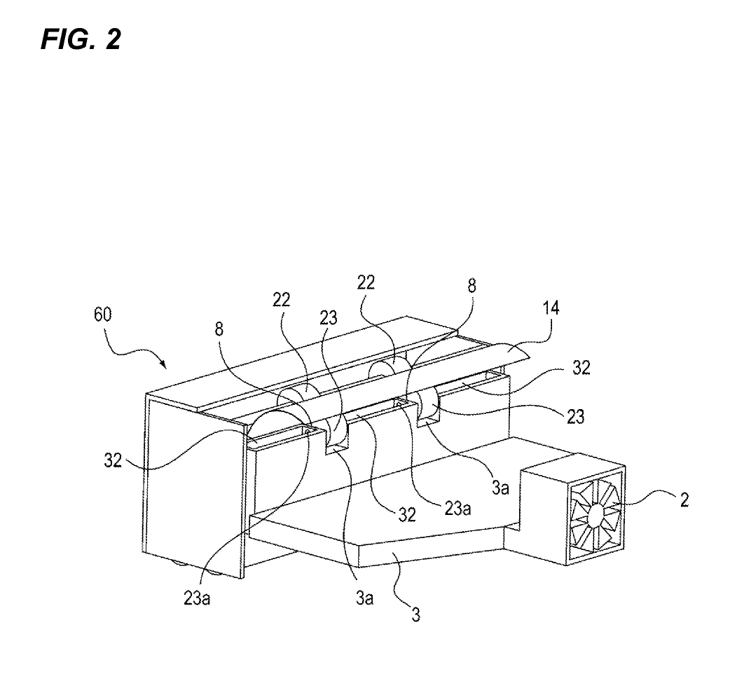

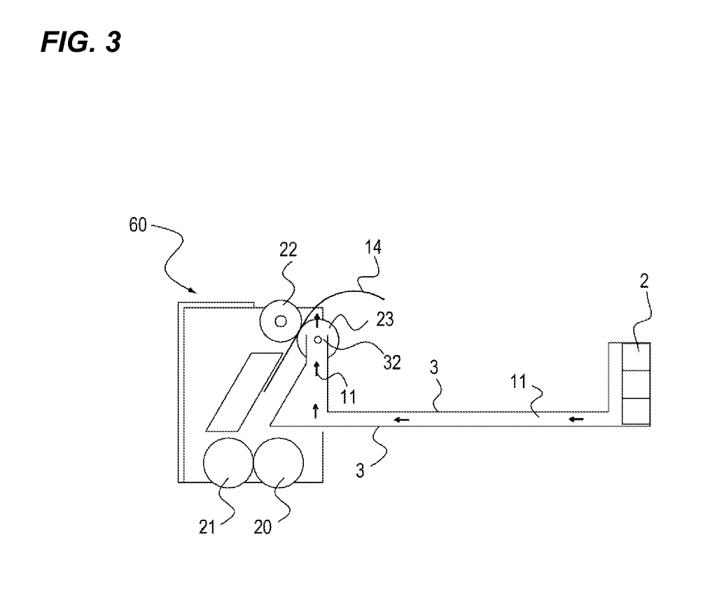

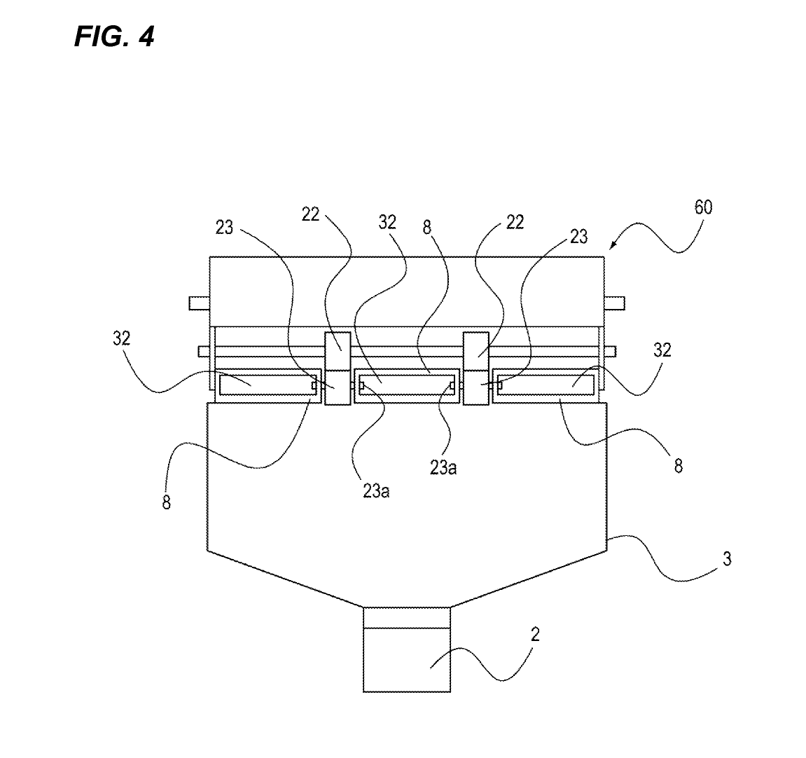

Accordingly, the toner image formed by, e.g., the process cartridge 9 and the laser scanner 25 constituting the toner image forming portion is transferred by, e.g., the intermediate transfer belt 18 and the transfer roller 17 onto the recording material 14, and the toner image is fixed onto the recording material 14 by the fixing device 60 serving as a fixing portion. Accordingly, the color image is formed on the recording material 14. When a monochrome image is formed on the recording material 14, only a toner image in black color may be formed on the photosensitive drum 1d, and the toner image may be transferred onto the recording material 14.

<Conveying portion> The recording material 14 having the toner image fixed thereon is discharged to a stacking portion 24 by the discharge roller 22 and the discharge driven roller 23 serving as a pair of rollers constituting a conveying portion. The external periphery of the discharge drive roller 23 is in contact with the surface of the recording material 14 where the image is formed. The discharge roller 22 and the discharge driven roller 23 serving as a pair of rollers constituting the conveying portion is provided at the downstream side with respect to the fixing device 60 in the conveying direction of the recording material and in proximity to the fixing device 60, and the discharge roller 22 and the discharge driven roller 23 serving as a pair of rollers constituting the conveying portion sandwiches and conveys the recording material 14.

<Cooling portion> FIG. 2 is a perspective explanatory diagram illustrating a configuration of a cooling portion provided in proximity to the conveying portion of the first embodiment. FIG. 3 is a sectional explanatory diagram illustrating a configuration of the cooling portion provided in proximity to the conveying portion of the first embodiment. FIG. 4 is a top view explanatory diagram illustrating a configuration of the cooling portion provided in proximity to the conveying portion of the first embodiment.

The recording material 14 on which the toner image is fixed by the fixing device 60 is sandwiched and conveyed by the discharge roller 22 and the discharge driven roller 23 constituting the pair of rollers serving as a conveying portion rotated by a driving source such as a motor, not shown. Then, the recording material 14 is stacked on the stacking portion 24.

At this occasion, as illustrated in FIG. 3, external air 11 drawn by an air-blowing fan 2 serving as an air-blowing portion which blows air is introduced into an air-blowing duct 3. The air-blowing duct 3 is coupled with the air-blowing fan 2, and is configured as a guide portion which guides the external air 11 (air) blown by the air-blowing fan 2 to the recording material 14 sandwiched and conveyed by the discharge roller 22 and the discharge driven roller 23 serving as a conveying portion.

At a terminating end portion of the air-blowing duct 3, a blowing port 32 is provided in proximity to the discharge roller 22 and the discharge driven roller 23. The blowing port 32 is made as an opening facing toward the recording material 14 sandwiched and conveyed by the discharge roller 22 and the discharge driven roller 23. As illustrated in FIG. 4, the blowing port 32 of the present embodiment is an opening at a position which located to avoid the discharge roller 22 and the discharge driven roller 23 serving as a pair of rollers.

The blowing port 32 is arranged to be aligned with the discharge roller 22 and the discharge driven roller 23 in the axial direction of the discharge roller 22 and the discharge driven roller 23. The blowing port 32 is also provided between plural discharge driven rollers 23 in the axial direction of the discharge driven roller 23. As illustrated in FIG. 4, the blowing port 32 is arranged inside of the external peripheral surface of the discharge driven roller 23 in the diameter direction of the discharge driven roller 23 (the conveying direction of the recording material). More specifically, the blowing port 32 is arranged at a position overlapping the discharge driven roller 23 in the diameter direction (position overlapping the discharge driven roller 23 as seen in the direction along the axial direction).

As illustrated in FIG. 2, the external air 11 introduced from the air-blowing fan 2 to the air-blowing duct 3 is discharged from the blowing port 32 divided into three parts in the axial direction of the discharge roller 22 and the discharge driven roller 23 provided within the fixing device 60. In the present embodiment, a rotation shaft 23a of the discharge driven roller 23 is rotatably, axially supported by an air-discharge wall 8 constituting a portion of the blowing port 32. A closing portion 3a for closing the air-blow is provided at a position of the air-blowing duct 3 that faces the discharge driven roller 23.

As illustrated in FIG. 3, the external air 11 discharged from the blowing port 32 is blown in a direction indicated by arrows in FIG. 3 to the surface of the recording material 14 discharged by the discharge roller 22 and the discharge driven roller 23 in the fixing device 60, so that the recording material 14 is cooled.

At this occasion, the external air 11 drawn by the air-blowing fan 2 is blown through the blowing port 32 of the air-blowing duct 3 to the recording material 14 sandwiched and conveyed by the discharge roller 22 and the discharge driven roller 23. However, a portion facing the discharge driven roller 23 is closed by the closing portion 3a, and therefore, the discharge roller 22 and the discharge driven roller 23 are not directly exposed to the external air 11 blown through the air-blowing duct 3. For this reason, the discharge roller 22 and the discharge driven roller 23, to which the external air 11 is not directly blown, are not cooled.

The air which is blown out of the blowing port 32 and is blown to the lower surface of the recording material 14 sandwiched and conveyed by the discharge roller 22 and the discharge driven roller 23 flows along the lower surface of the recording material 14 which is being discharged and flows to the upper side of the stacking portion 24. The air blow direction is configured such that a component in a direction along the nip line of the discharge roller 22 and the discharge driven roller 23 exists as a component of air blow direction which is blown from the blowing port 32 of the air-blowing duct 3.

Therefore, the toner image heated and pressurized by the fixing film 20 and the pressure roller 21 of the fixing device 60 is fixed to the recording material 14. Thereafter, the toner image is prevented from being melted again, because of the high-temperature recording material 14 sandwiched and conveyed by the discharge roller 22 and the discharge driven roller 23 and discharged onto the stacking portion 24.

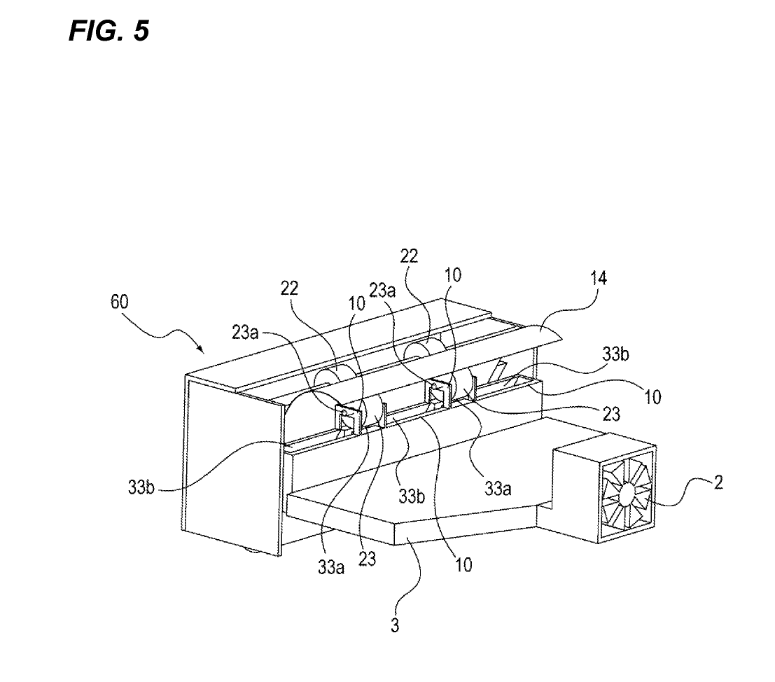

Further, the temperature difference between the recording material 14 discharged immediately after the heating and fixing process in the fixing device 60 and the discharge driven roller 23 and discharge roller 22 can be reduced, and unevenness of cooling of the toner image due to the temperature difference between the recording material 14 and the discharge driven roller 23 and discharge roller 22 can be prevented.

[Second Embodiment] Subsequently, a configuration of the second embodiment of the image forming apparatus according to the present invention will be described with reference to FIGS. 5 to 7. It should be noted that those configured in the same manner as those of the first embodiment are denoted with the same reference numerals, or although denoted with different reference numerals, the same member names are given thereto, and the description thereabout will not be repeated here.

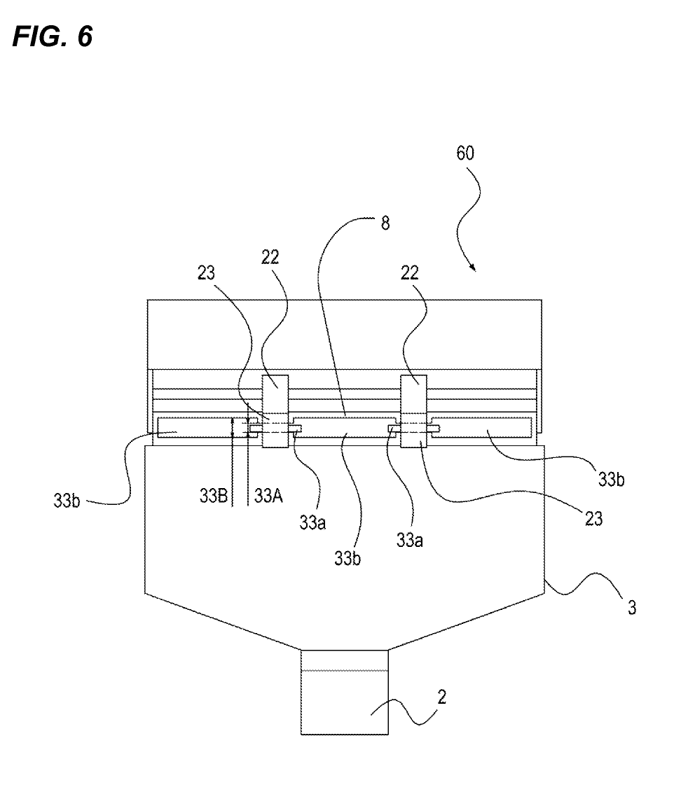

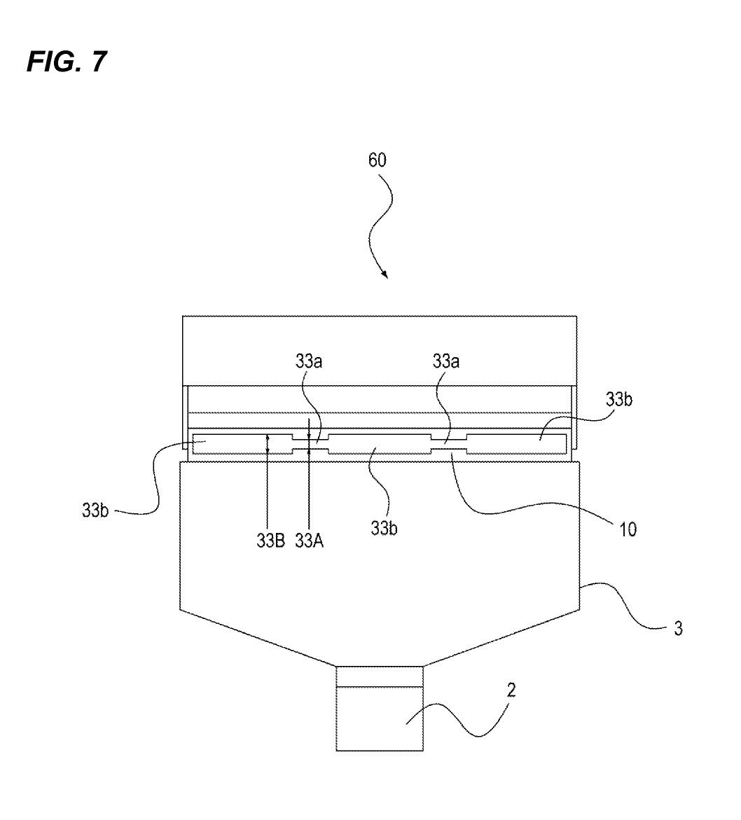

FIG. 5 is a perspective explanatory diagram illustrating a configuration around a discharge portion of an image forming apparatus according to the present embodiment. FIG. 6 is a top view explanatory diagram illustrating a configuration around the discharge portion of the image forming apparatus according to the present embodiment. FIG. 7 is a top view explanatory diagram illustrating a configuration around the blowing port according to the present embodiment.

In the present embodiment, at a terminating end portion of an air-blowing duct 3, blowing ports 33a, 33b are provided in proximity to a discharge roller 22 and a discharge driven roller 23. The blowing ports 33a, 33b are made as an opening facing toward a recording material 14 sandwiched and conveyed by the discharge roller 22 and the discharge driven roller 23.

External air 11 drawn by an air-blowing fan 2 reaches blowing ports 33a, 33b via the air-blowing duct 3. The second embodiment has the same configuration as the first embodiment in that the external air is blown through the blowing ports 33a, 33b to the recording material 14 sandwiched and conveyed by the discharge roller 22 and the discharge driven roller 23 to cool the recording material 14.

As illustrated in FIG. 7, the blowing ports 33a, 33b of the present embodiment is configured such that an opening width 33A in the recording material conveying direction (the vertical direction of FIG. 7) of the blowing port 33a at a position facing the discharge roller 22 and the discharge driven roller 23 serving as a pair of rollers is less than an opening width 33B of the blowing port 33b. The opening width 33B is an opening width in the recording material conveying direction (the vertical direction of FIG. 7) of the blowing port 33b at a position not facing the discharge roller 22 and the discharge driven roller 23.

As illustrated in FIGS. 5 to 7, the blowing ports 33a, 33b include the blowing port 33a facing the discharge roller 22 and the discharge driven roller 23 with an air-discharge wall 10 and the blowing port 33b not facing the discharge roller 22 and the discharge driven roller 23.

As illustrated in FIG. 7, the opening width 33A of the blowing port 33a is less than the opening width 33B of the blowing port 33b. Accordingly, the external air 11 discharged from the blowing port 33b not facing the discharge roller 22 and the discharge driven roller 23 cools the recording material 14. At this occasion, a large amount of air is blown onto the surface of the recording material 14 discharged as being sandwiched and conveyed by the discharge roller 22 and the discharge driven roller 23 provided in the fixing device 60 to cool the recording material 14.

On the other hand, since the opening width 33A is small, there is small amount of external air 11 discharged from the blowing port 33a facing the discharge roller 22 and the discharge driven roller 23. Therefore, the discharge roller 22 and the discharge driven roller 23 is difficult to be cooled.

Accordingly, the toner image heated and pressurized by the fixing film 20 and the pressure roller 21 of the fixing device 60 is fixed onto the recording material 14. Thereafter, the toner image is prevented from being melted again, because of the high-temperature recording material 14 sandwiched and conveyed by the discharge roller 22 and the discharge driven roller 23 and discharged onto a stacking portion 24.

Further, the temperature difference between the recording material 14 discharged immediately after the heating and fixing process in the fixing device 60 and the discharge driven roller 23 and discharge roller 22 can be reduced, and unevenness of cooling of the toner image due to the temperature difference between the recording material 14 and the discharge driven roller 23 and discharge roller 22 can be prevented. The other configuration is configured in the same manner as the first embodiment, and the same effects can be obtained.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2013-075601, filed Apr. 1, 2013, which is hereby incorporated by reference herein in its entirety.

What is claimed is:

1. An image forming apparatus comprising:
a toner image forming portion configured to form a toner image on a recording material;
a fixing portion configured to fix the toner image formed by the toner image forming portion onto the recording material;
a pair of rollers which is provided at a downstream in a conveying direction of the recording material with respect to the fixing portion, and which sandwiches and conveys the recording material;
an air-blowing portion configured to blow air; and
a guide portion configured to guide the air blown by the air-blowing portion to the recording material conveyed by the pair of rollers,
wherein the guide portion includes a blowing port in proximity to the pair of rollers and at a position avoiding the pair of rollers.

2. An image forming apparatus comprising:
a toner image forming portion configured to form a toner image on a recording material;
a fixing portion configured to fix the toner image formed by the toner image forming portion onto the recording material;
a pair of rollers which is provided at a downstream in a conveying direction of the recording material with respect to the fixing portion, and which sandwiches and conveys the recording material;
an air-blowing portion configured to blow air; and
a guide portion configured to guide the air blown by the air-blowing portion to the recording material conveyed by the pair of rollers,
wherein the guide portion includes a blowing port at a position different from the pair of rollers in a direction perpendicular to a direction in which the pair of rollers conveys the recording material, and
the blowing port is provided at a position overlapping a rotation body, which is one of the pair of rollers, in a direction in which the pair of rollers conveys the recording material.

3. An image forming apparatus comprising:
a toner image forming portion configured to form a toner image on a recording material;
a fixing portion configured to fix the toner image formed by the toner image forming portion onto the recording material;
a pair of rollers which is provided at a downstream in a conveying direction of the recording material with respect to the fixing portion, and which sandwiches and conveys the recording material;
an air-blowing portion configured to blow air; and
a guide portion configured to guide air blown by the air-blowing portion to a recording material conveyed by the conveying portion,
wherein the guide portion has a blowing port at a position different from the pair of rollers in a direction perpendicular to a direction in which the pair of rollers conveys the recording material,
the blowing port is provided at a position overlapping a rotation body of one of the pair of rollers in a diameter direction of the rotation body of the one of the pair of rollers.

4. The image forming apparatus according to claim 2, wherein a plurality of pair of rollers is provided in a direction perpendicular to a direction in which the pair of rollers conveys the recording material.

5. The image forming apparatus according to claim 2, wherein the pair of rollers is a discharge roller pair which discharges the recording material to outside of a main body of the apparatus.

6. The image forming apparatus according to claim 5, wherein air blow out from the blowing port to the recording material flows above the main body of the apparatus.

7. The image forming apparatus according to claim 2, wherein the pair of rollers includes a driving rotation body and a driven rotation body which rotates by being driven by the driving rotation body, and a rotation shaft of the driven rotation body is attached to the guide portion.

8. An image forming apparatus comprising:
a toner image forming portion configured to form a toner image on a recording material;
a fixing portion configured to fix the toner image formed by the toner image forming portion onto the recording material;
a pair of rollers which is provided at a downstream in a conveying direction of the recording material with respect to the fixing portion, and which sandwiches and conveys the recording material;
an air-blowing portion configured to blow air; and
a guide portion configured to guide the air blown by the air-blowing portion to the recording material conveyed by the pair of rollers,
wherein the guide portion includes blowing ports at a position facing the pair of rollers and a position not facing the pair of rollers,
in a direction in which the pair of rollers conveys the recording material, the blowing port at the position facing the pair of rollers is smaller than the blowing port at the position not facing the pair of rollers.
